(19) United States
(12) Patent Application Publication
(10) Pub. No.: US 2001/0026048 A1
(43) Pub. Date: Oct. 4, 2001

(54) Duct joining system

(76) Inventors: John P. Proctor, Fairfax, CA (US); Robert C. deKieffer, Boulder, CO (US)

Correspondence Address: Michael J. Halbert, SKJERVEN MORRILL MacPHERSON LLP, Suite 700, 25 Metro Drive, San Jose, CA, 95110-1349, US

(21) Appl. No.: 09/753,122

(22) Filed: Dec. 29, 2000

Related U.S. Application Data
(63) Continuation-in-part of application No. 09/223,044, filed on Dec. 30, 1998.

(30) Foreign Application Priority Data
Dec. 10, 1999 (CA) 2292392

(51) Int. Cl. F16L 21/05

(52) U.S. Cl. 277/603

(57) ABSTRACT

A duct joining system for providing an air-tight seal and mechanical connection for ducts and fittings is disclosed. The duct joining system includes a flexible gasket that provides the seal and mechanical connection between a first duct and a second duct. The flexible gasket is, e.g., mounted on a male end and is affixed at an angle relative to normal of the male end of the duct. The female end of the other duct includes a raised bead in which the flexible gasket is seated when the ducts are properly joined. The angled flexible gasket seated in the raised bead forms an air-tight seal as well as fastens or locks the male end to the female end. If desired, the flexible gasket may be mounted in the female end and is seated in a depressed bead in the male end when properly joined. Alternatively, when a flexible duct is used, a clamp may be clamped over the female end of the flexible duct and over the male end of a fitting to provide an air tight seal and fastened connection.

CROSS-REFERENCE TO RELATED APPLICATION

This application is a continuation-in-part of Ser. No. 09/223,044, filed on Dec. 30, 1998.

This invention was made with Government support under contract number DE-FG03-76SF00098 awarded by the United States Department of Energy and CRADA BG-97-352-01. The Government has certain rights in this invention.

### FIELD OF THE INVENTION

The present invention relates to a duct joining system that in a single design provides and air-tight seal and a locking mechanism to hold the ducts together.

### BACKGROUND

Air ducts, such as that used with central furnaces and air conditioning units and the like, are typically made from sheet metal or a plastic flexible material having cylindrical, rectangular, or other cross sections as are well known in the art. The ducts are conventionally joined by sliding an end of one duct into an end of another duct and providing some form of mechanical fastening, such as screws or clamps. The connection should then be sealed with a sealant such as duct tape, mastic or other sealant. Often ducts are joined to one another or to a heating or cooling appliance or to fittings in a similar manner.

Unfortunately, initially or overtime, the seal and mechanical fastening are compromised and air leaks at the duct joint. In many cases the mechanical connection is partially or fully broken. Thus, air from the duct system leaks into areas of the building where the air is neither intended nor desired, such as in the attic, basement, or within the walls. Consequently, the energy that was used to heat or cool the escaped air, in addition to the energy used to move the escaped air, is wasted.

Attempts to prevent the unintentional leakage of air from duct joints include placing a gasket between the two ducts. While gaskets prevent air from leaking out of the duct joints, the ducts still require some fastening mechanism to prevent the ducts from slipping apart during installation as well as over time. Thus, it is good practice to securely fasten the joints of a duct together, and in fact the Uniform Mechanical Code §602.4 requires a mechanical connection between joints. Sheet metal screws or other similar fasteners are sometimes used to prevent partial or complete disconnection of the ducts and to meet the requirements of the Uniform Mechanical Code. However, the installation of the duct system requires holding ducts in place while fastening the joints, which can be awkward and time consuming and is often simply not done, particularly when the installer is uninformed or is in a hurry. Consequently, many duct joints are held together with nothing more than duct tape, which quickly fails permitting partial or complete disconnection of the ducts.

Thus, there is a need for a duct joining system that quickly and easily fastens and seals ducts together to form an air-tight conduit.

### SUMMARY

A duct joining system that simultaneously seals and locks the joint in place, consisting of a flexible seal and locking mechanism retained on the male end of a first duct at a relative angle to normal of the male end of the duct. The female end of a second duct consists of two sections near the end of the duct. The first section is of a lesser cross sectional area than the second section. Upon installation of the male end of the first duct into the female end of the second duct, the flexible seal and locking mechanism is compressed as it moves through the first section (of lesser cross section). When the flexible seal and locking mechanism fully enters the second (larger cross section) the seal and locking mechanism expand into place and both seal and lock the joint. The diameters, angles, and flexibility of the components are controlled such that the force required to pull the joint apart exceeds the force required to assemble the joint by at least a factor of three.

A stop is provided that prevents the seal and locking mechanism from being inserted too far into the female end. The stop ensures that the seal and locking mechanism is in the proper section of the female end so the seal and lock are engaged in the larger cross section.

The gasket and locking mechanism is retained on the male end by friction and interference caused by stretching the mechanism over a relatively larger cross section of the male end of the duct.

When the female end of the joint consists of a flexible duct, the lesser cross section of the female end may be provided by a clamping mechanism applied after the male end is installed into the female end. In any case the flexible seal and locking mechanism provides the majority of the resistance to pulling the joint apart.

### BRIEF DESCRIPTION OF THE DRAWINGS

The above and other features, aspects, and advantages of the present invention will become better understood with regard to the following description, appended claims, and accompanying figures, where:

FIGS. 1 and 2 show perspective views of two ducts separated and joined together, respectively, with a duct joining system in accordance with an embodiment of the present invention;

FIG. 3 is a cut-away side view of the duct joining system shown in FIG. 2;

FIGS. 4 and 5 show perspective views of a flexible duct and a fitting separated and joined together, respectively, with a duct joining system in accordance with another embodiment of the present invention;

FIGS. 6A and 6B are perspective views of clamps that can used with the duct joining system shown in FIGS. 4 and 5; and

FIG. 7 is a cut-away side view of the duct joining system shown in FIG. 5.

FIGS. 8 and 9 are cut-away side views of other embodiments of a duct joining system.

### DETAILED DESCRIPTION

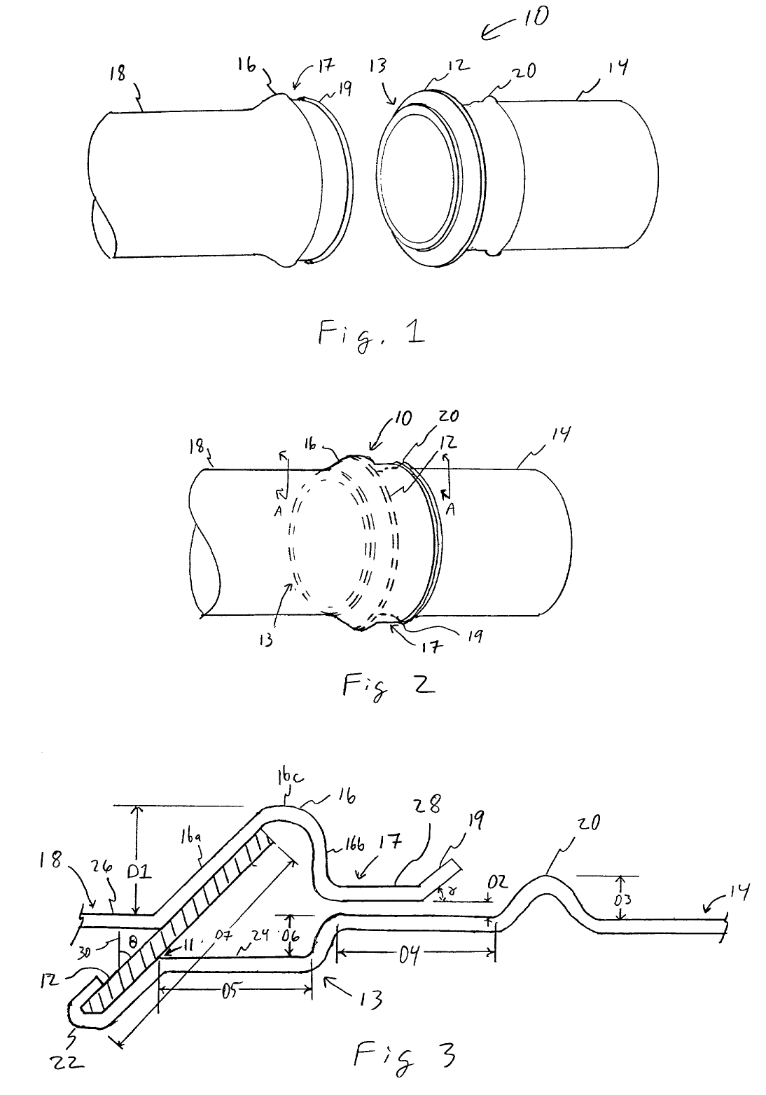

FIGS. 1 and 2 show perspective views of ducts 14 and 18 separated and joined together, respectively, with duct joining system 10, in accordance with an embodiment of the present invention. It should be understood that duct joining system 10 can be used with fittings as well as ducts. As is well understood in the art, fittings, such as elbow bends and boots, are similar to ducts, but are typically used to connect one duct to another duct or to an input/output device, e.g., an air conditioner/heater unit or vent. The terms “duct” and “fitting” may be used interchangeably for purposes of the present disclosure.

Duct joining system 10 includes a flexible gasket 12 at one end (the male end 13) of a duct 14 and a raised bead 16 near one end (the female end 17) of another duct 18. It should be understood that a single duct, e.g., duct 14, will typically include a male end 13 at one end (shown in FIGS. 1 and 2) and a female end 17 at the other end (not shown in FIGS. 1 and 2 for the sake of clarity). As shown in FIGS. 1 and 2, both flexible gasket 12 and raised bead 16 substantially extend around the perimeter of male end 13 and female end 17, respectively. A lead-in, which is in the form of an angled lip 19, is also included substantially extending around the circumference of the end of female end 17 to ease insertion of the male end 13 into female end 17 and to prevent damage to flexible gasket 12 during insertion. A stop bead 20 prevents male end 13 from being inserted too far into female end 17. Once properly joined, flexible gasket 12, shown in FIG. 2 by dotted lines, is seated in raised bead 16, thereby creating an air-tight seal between ducts 14 and 18. Moreover, because flexible gasket 12 is seated in raised bead 16, ducts 14 and 18 are mechanically fastened together. Thus, advantageously, no additional fasteners are required with duct joining system 10.

While FIGS. 1 and 2 show ducts 14 and 18 as round, it should be understood that the shape illustrated in FIGS. 1 and 2 is exemplary and that any shaped ducts may be joined using duct joining system 10, including but not limited to oval, rectangular, square, and flexible ducts. Moreover, duct joining system 10 may be used with any size ducts.

FIG. 3 is a cut-away side view of duct joining system 10 along lines A-A, shown in FIG. 2. As male end 13 is inserted into female end 17, angled lip 19 at the terminal end of female end 17 acts as a lead-in to ease insertion and to prevent female end 17 from damaging flexible gasket 12. Stop bead 20 prevents male end 13 from being inserted too far into female end 17. Once male end 13 is inserted into female end 17, flexible gasket 12 is seated in raised bead 16, as illustrated in FIG. 3. While flexible gasket 12 can be made of rubber, soft plastic or some similar type material, the term “flexible gasket” should be understood to include any gasket that flexes, bends, or is hinged. Thus, for example, flexible gasket 12 may be made of stiff sheet metal or plastic that is hinged at point 11, shown in FIG. 3. The hinged flexible gasket 12 would be made of overlying flaps with each flap hinged at point 11. The hinge permits flexible gasket 12 to bend during insertion of male end 13 into female end 17. A hinged flexible gasket 12 may be biased, e.g., with a spring, to open and engage raised bead 16 once male end 13 is properly inserted into female end 17. Raised bead 16 may be made of or contain a flexible or soft material, e.g., rubber or some similar material, in which a flexible gasket 12 seats to create a seal.

It should be understood that angled lip 19 is an exemplary form of a lead-in and that other lead-ins may be used, including but not limited to completely rolling over the terminal end of female end 17. Moreover, a lead-in may not be used if desired.

FIG. 3 shows flexible gasket 12 affixed to male end 13 at an angle by a rolled end joint 22, in accordance with an embodiment of the present invention. Rolled end joint 22 rolls over and pinches flexible gasket 12 securely affixing flexible gasket 12 to male end 13. It should be understood that there are a variety of methods that may also be used to affix flexible gasket 12 to male end 13. For example, only small portions or fingers of male end 13 may be used to hold flexible gasket 12. Alternatively, a flexible gasket 12 may be attached to a retainer, which holds flexible gasket 12 at the desired angle. The retainer is then connected to the end of male end 13, thereby obviating the need to form rolled end joint 22. Other methods of affixing flexible gasket 12 to male end 13 will be apparent to those of ordinary skill in the art in light of the present disclosure. FIGS. 8 and 9, for example, shows other embodiments of mounting a flexible gasket to the male end through the use of tension and friction, as will described in more detail below.

Adjacent to rolled end joint 22 and flexible gasket 12 is an indented portion 24 of male end 13. Indented portion 24 permits flexible gasket 12 to be flattened out during insertion of male end 13 into female end 17. Thus, flexible gasket 12 does not interfere with the insertion of male end 13 into female end 17.

Raised bead 16 on female end 17 is configured to permit flexible gasket 12 to be seated when ducts 14 and 18 are properly joined. By way of an example, as shown in FIG. 3, raised bead 16 is configured with a relatively gradually sloping sidewall 16a and a sharply sloping sidewall 16b. The gradually sloping sidewall 16a of raised bead 16 forms approximately the same angle relative to female end 17 as formed by flexible gasket 12 relative to inserting end 13. Thus, when flexible gasket 12 is seated in raised bead 16, a relatively air-tight seal is formed between flexible gasket 12 and raised bead 16. If desired flexible gasket 12 may be longer than shown in FIG. 3, such that when flexible gasket 12 is seated in raised bead 16 flexible gasket presses against the top portion 16c of raised bead 16 and/or may press against sidewall 16b. Thus, flexible gasket 12 may press against any single sidewall 16a, 16b, or 16c or combination thereof. Further, the configuration of raised bead 16 may be altered if desired. Thus, sidewalls 16a and 16b may have the same or similar angles, may have concave, convex, or a combination of curvatures, and may have different relative dimensions than those shown in FIG. 3.

Flexible gasket 12 and raised bead 16 form a fastened joint between male end 13 and female end 17. Once flexible gasket 12 is seated in raised bead 16, an attempt to separate male end 13 from female end 17 will cause flexible gasket 12 to press against sidewall 16b. Because flexible gasket 12 is held at an angle, removal of male end 13 from female end 17 will be met with resistance. Thus, ducts 14 and 18 are fastened or locked together by duct joining system 10. The amount of resistance in removing male end 13 from female end 17 may be controlled by changing the materials, dimensions and angles of flexible gasket 12 as well as altering the dimensions of raised bead 16 and the amount of clearance between male end 13 and female end 17, i.e., dimension D2 shown in FIG. 3. Incidentally, these parameters may also effect the resistance in inserting male end 13 into female end 17 to achieve a good seal.

It should be understood that the particular dimensions and materials used in the duct joining system 10 may be varied as desired, but should be appropriate for the particular size and desired use of the ducts. Nevertheless, by way of an example, ducts 14 and 18 may be 6 inch outside diameter pipes made of conventional 26 gauge galvanized sheet metal, which is approximately 0.018 inches thick. The raised bead 16 on female end 17 is raised approximately 0.25 inches from an inside portion 26 of duct 18 (shown as dimension D1), giving raised bead 16 an outside diameter of approximately 6.56 inches. The terminal portion 28 of female end 17 has an outside diameter of approximately 6.13 inches and there is a separation of approximately 0.06 inches (shown as dimension D2) between the interior of terminal portion 28 and the outside diameter of duct 14, which is 6 inches. The angled lip 19 is approximately 45 degrees from horizontal (angle γ).

Stop bead 20 is raised approximately 0.13 inches above the 6 inch outside diameter of duct 14 (shown as dimension D3). The distance between stop bead 20 and indented portion 24 is approximately 0.35 inches (shown as dimension D4), but this dimension may be altered as long as flexible duct 12 and raised bead 16 are properly aligned. Indented portion 24 is approximately 1.44 inches long (shown as dimension D5) and approximately 0.08 inches deep (shown as dimension D6). It should be understood that indented portion 24 should be deep enough and long enough to accommodate flexible gasket 12. Rolled end joint 22 has an inside diameter of approximately 5.44 inches. It should be understood, however, that the inside diameter of rolled end joint 22 contributes to the resistance of air flow through the joined ducts. Thus, it may be desirable to reduce the resistance to air flow by using a smaller end joint 22 that forms a larger inside diameter.

Flexible gasket 12 is approximately 0.63 inches long (shown as dimension D7) and 0.06 inches thick. Flexible gasket 12 is held at an angle of approximately 45 degrees (shown as angle θ) with respect to the normal (shown as line 30) of duct 14. Sloping sidewall 16a of raised bead 16 has approximately the same 45 degree angle.

Flexible gasket 12 is made of rubber, flexible plastic, or some similar type material. By way of an example, flexible gasket 12 is made from EPDM rubber, manufactured by Bay Rubber Company, located in Oakland, Calif. Flexible gasket 12 may be a molded conical form of material, such as rubber, that has an outside diameter of 5.96 inches with a hole in the center with an inside diameter of 5.52 inches. If duct 14 had a shape other than circular, e.g., oval, square, or rectangular, flexible gasket 12 would have a comparable shape and a hole in the center also with a comparable shape. Flexible gasket 12 is slid onto male end 13 and rolled end joint 22 is formed to secure flexible gasket 12 to duct 14. Flexible gasket 12 may also be formed using a flat piece of gasket material. Rolled end joint 22 is formed pinching the gasket material to form the conical configuration of flexible gasket 12, shown in FIG. 3, such that the two ends of the gasket material are placed proximate to each other. The ends of the gasket material, once affixed to male end 13 need not be glued together.

The sheet metal of ducts 14 and 18 may be bent and shaped to form duct joining system 10 using conventional sheet metal shaping methods, such as rolling, stamping, folding, or any other appropriate techniques. If ducts 14 and 18 are made of other material, duct joining system 10 may be formed using conventional methods for that particular material. For example, if ducts 14 and 18 were made of plastic, duct joining system 10 may be formed using molding or other plastic fabrication techniques.

FIGS. 4 and 5 show perspective views of a fitting 60 and a duct 52 separated and joined together, respectively, with duct joining system 50 in accordance with another embodiment of the present invention.

Duct joining system 50 is similar to duct joining system 10 shown in FIGS. 1, 2, and 3, like designated elements being the same. However, duct joining system 50 includes a fitting 60, which is similar to duct 14 shown in FIGS. 1, 2, and 3, and includes a male end 13 with a flexible gasket 12 and a stop bead 20. Duct joining system 50 also includes a flexible duct 52 that, as shown in FIG. 4, does not have a raised bead. Flexible duct 52 may be made from plastic, rubber, cloth, or similar type material and may include a helical supporting wire. It should be understood that flexible duct 52 typically includes an overlying layer of insulation and another overlying layer serving as a vapor barrier. The overlying insulation layer and vapor barrier layers are not shown on flexible duct 52 for the sake of clarity.

Fitting 60 may be used to join flexible duct 52 to an input or output device, such as an air conditioner/heater unit or a vent. Fitting 60 may also be used to join two flexible ducts 52 together, in which case, fitting 60 will include another male end in mirror image to male end 13. Two flexible ducts 52 may then be joined end to end using a fitting 60 with two male ends 13.

As shown in FIG. 5, duct joining system 50 includes a band clamp 54 that is used to hold flexible duct 52 securely on fitting 60 once flexible duct 52 is slipped over fitting 60. In another embodiment, band clamp 54 is not used with duct joining system 50. The resistance provided by angled flexible gasket 62 pressing against flexible duct 52 is sufficient to fasten flexible duct 52 to fitting 60.

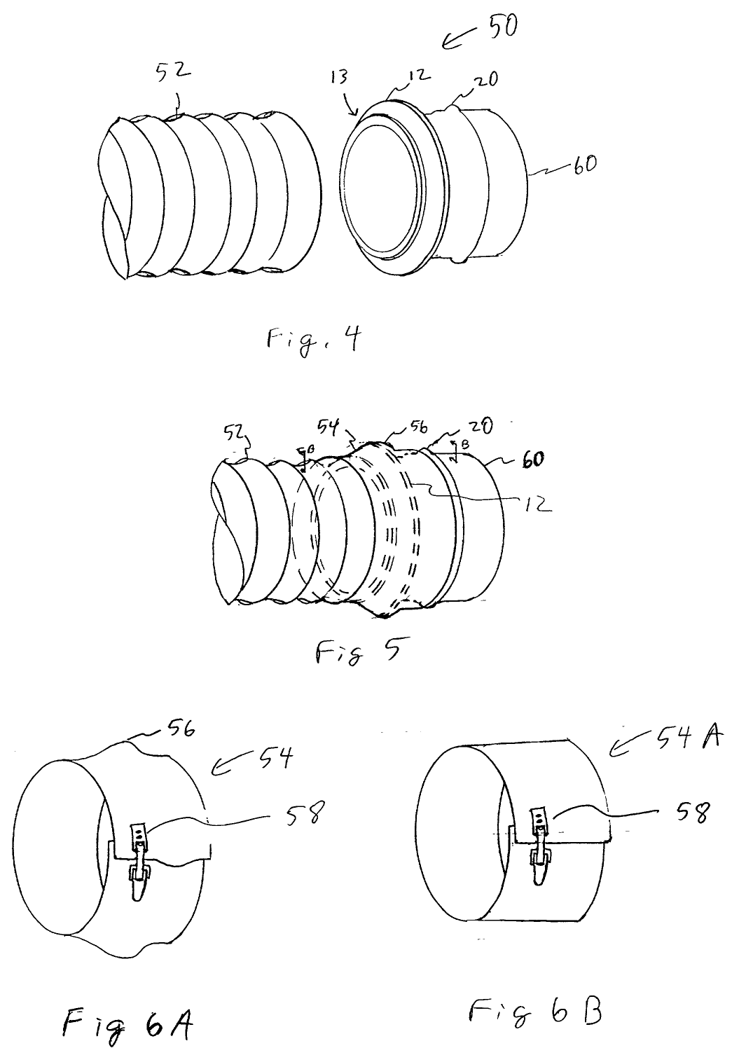

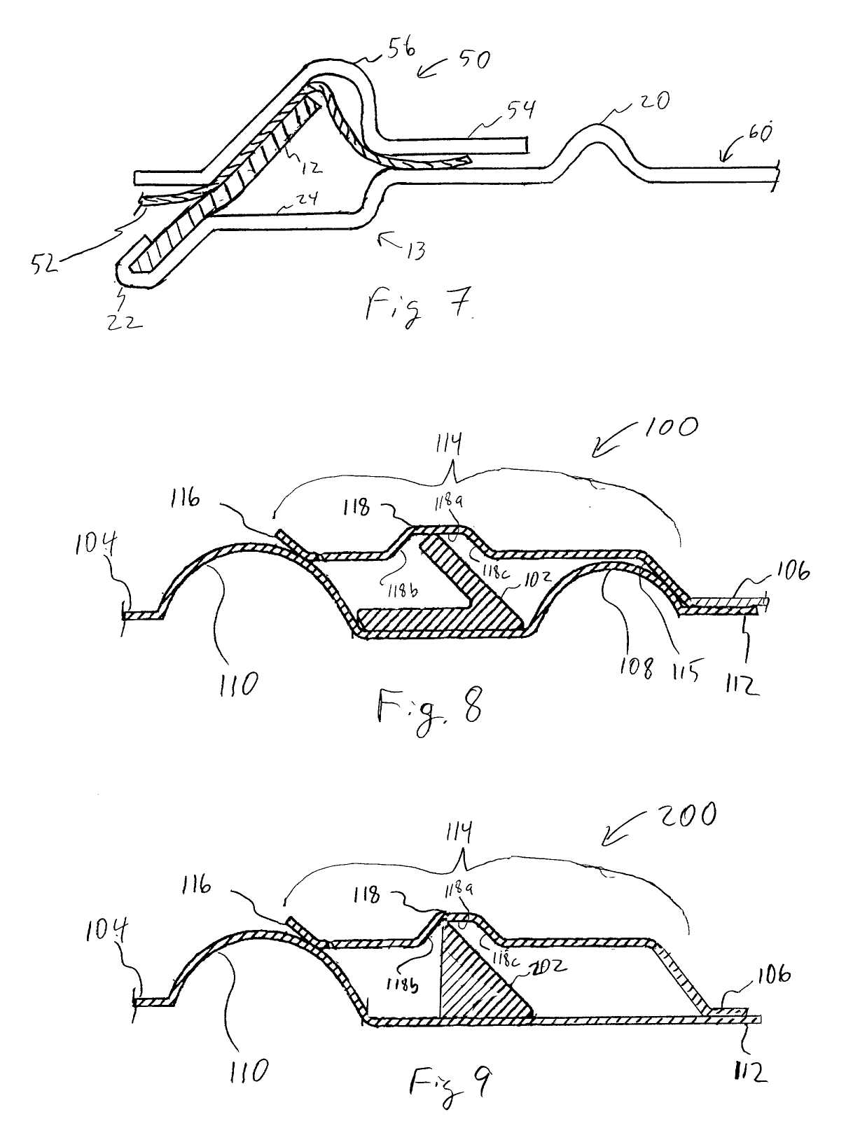

FIG. 6A is a perspective view of band clamp 54. Band clamp 54 includes a raised bead 56, which is similar to raised bead 16, shown in FIG. 3. In addition, band clamp 54 includes a fastening mechanism 58 to tighten band clamp 54. FIG. 6A shows an over-center toggle type clamp device that may be spot welded or pop-riveted or otherwise fastened onto band clamp 54. However, it should be understood that other types of fastening mechanisms may be used, including a worm screw, tie wraps, or any other appropriate mechanism. Band clamp 54 may be made of plastic, sheet metal, or any other appropriate material and may be formed in a manner similar to that described for female end 17 shown in FIG. 3. When duct joining system 50 is used to join two flexible ducts together, i.e., fitting 60 has two opposing male ends, either two band clamps 54 may be used or one band clamp that has two raised beads 56 in mirror image to accommodate the two male ends 13 may be used.

FIG. 6B is a perspective view of another clamp 54A that may be used in accordance with the present invention. As shown in FIG. 6B, clamp 54A does not include a raised bead, but may use a fastening mechanism 58. In another embodiment, a self locking cable, for example a nylon cable, may be used instead of a clamps 54 or 54A. The cable,or clamp 54A is placed over flexible duct 12 past flexible gasket 12 such that flexible gasket will interfere with removal of flexible duct 52. Thus, flexible gasket 12 will form a seal with flexible duct 52 as well as a mechanical connection.

FIG. 7 is a cut-away side view of duct joining system 50 along lines B-B shown in FIG. 5. As shown in FIG. 7, once male end 13 is inserted into flexible duct 52, flexible gasket 12 is seated within flexible duct 54 creating an air-tight seal. In addition, band clamp 52 may be used to clamp flexible duct 52 against flexible gasket 12 to increase the seal as well as to prevent flexible duct 52 from slipping off male end 13. Stop bead 20 on fitting 60 may be used to properly align band clamp 54 over flexible duct 52 and fitting 60.

FIG. 8 is a cut-away side view of another embodiment of a duct joining system 100. As shown in FIG. 8, a flexible gasket 102 is used to create a seal and a mechanical connection between male end 104 and female end 106. Flexible gasket 102 is mounted on male end 104 between a pair of raised beads 108 and 110. The raised beads prevent flexible gasket 102 from slipping on male end 104 while the male end 104 and female end 106 are being joined or if an attempted separation of the male and female ends 104 and 106 occurs. The area between raised beads 108 and 110 is an indentation that can accommodate flexible gasket during insertion of the male end 104 into the female end 106.

As shown in FIG. 8, flexible gasket 102 has a “V” configuration with one arm 102a laying against the outer wall of male end 104 and the sealing arm 102b being held at an angle relative to normal of the male end 104. Sealing end 102b of flexible gasket 102 extends away from the front 112 of the male end. Flexible gasket 102 is made of rubber, flexible plastic, or some similar type material in a conventional manner. By way of an example, flexible gasket 102 is made from EPDM rubber, manufactured by Bay Rubber Company, located in Oakland, Calif. Of course, other similar types of configurations for the flexible gasket 102 may be used, such as a solid arrow head shape, as shown in FIG. 9.

FIG. 9 shows a cut-away side view of another embodiment of a duct joining system 200, like designated elements being the same. As shown in FIG. 9, “V” shaped flexible gasket 102 (FIG. 8) can be replaced with a solid arrow head shaped flexible gasket 202. In addition, if desired raised bead 108 may be removed as shown in FIG. 9. Without raised bead 108, flexible gasket 202 is held in place with tension and friction. Of course, if desired, flexible gasket 202 may be glued in place as well.

Female end 106 has an increased diameter portion 114 to accommodate raised bead 108 as the male end 104 is inserted into the female end 106 over raised bead 108 and flexible gasket 102. As shown in FIG. 8, the inside wall 115 of portion 114 contacts raised bead 108 when the male end and female ends are joined. In addition, the outer end of portion 114, which can include angled lip 116 to ease insertion of the male end 104 into female end 106 and to prevent damage to flexible gasket 102 during insertion, contacts raised bead 110. Thus, raised beads 108 and 110 both act as stop beads to prevent male end 104 from being inserted too far into female end 106. Of course, if desired, raised beads 108 110 may act together or independently as stop beads.

Female end 106 also includes a raised bead 118 that accommodates flexible gasket 102 once the male end 104 is joined with the female end 106. Flexible gasket 102 should press against the top surface 118a or the side walls 118b or 118c of raised bead 118 to create a relatively air-tight seal. In addition, flexible gasket 102 and raised bead 118 form a fastened joint between male end 104 and female end 106. Once flexible gasket 102 is seated in raised bead 118, an attempt to separate male end 104 from female end 106 will cause flexible gasket 12 to press against sidewall 11 8b. Because flexible gasket 102 is held at an angle, removal of male end 104 from female end 106 will be met with resistance. Thus, the male end 104 and the female end 106 are mechanically fastened together by duct joining system 100.

It should be understood that if desired, the flexible gasket of the present invention may be mounted on the inside of the female end as opposed to the outside of the male end. This may be seen in FIGS. 3, 7 and 8 by altering the female end for the male end. Thus, for example, as shown in FIG. 8, flexible gasket 102 may be mounted on the inside of a female end, which in this embodiment is labeled as duct 104 while the male end is duct 106. With flexible gasket 102 mounted on the inside of a female end, beads 108 and 110 would be depressed beads. The flexible gasket 102 would then seat into a depressed bead 118. Moreover, the duct 106 would include a decreased diameter portion 114 so that duct 106 may slide pass bead 108 and flexible gasket 102.

Although the present invention has been described in considerable detail with reference to certain versions thereof, other versions are possible. For example, other materials, shapes, and dimensions may be used than those illustrated. Further, it should be understood that an equivalent system may use the flexible gasket on the inside of the female end with the flexible gasket seated in an indented bead in the male end. Therefore, the spirit and scope of the appended claims should not be limited to the description of the versions depicted in the figures.

What is claimed is:

1. A duct joining system, comprising:
a first duct having a male end, said first duct having a first bead on said male end;
a flexible seal and locking mechanism retained on said male end of said first duct between said first bead and an end of said first duct; and
a second duct having a female end having a first cross sectional area and a second bead of a second cross sectional area that is greater than said first cross sectional area, said second duct may be joined to the first duct by sliding said female end over said male end, said flexible seal and locking mechanism being compressed within said first cross sectional area, said flexible seal and locking mechanism expanding into said second bead to form both a seal and a mechanical lock that provides resistance to the separation of said first duct and said second duct greater than the resistance to the joining of said first duct and said second duct.

2. The duct joining system of claim 1, wherein said flexible seal and locking mechanism is a flexible gasket held on said male end at an angle relative to normal and away from said end of said first duct.

3. The duct joining system of claim 1, wherein said resistance to the separation of said first duct and said second duct is at least three times greater than said resistance to the joining of said first duct and said second duct.

4. The duct joining system of claim 1, wherein said first bead acts as a stop bead to ensure said second duct is properly positioned with said first duct when said first duct and said second duct are joined.

5. The duct joining system of claim 1, further compromising a third bead on said first duct located between said flexible seal and locking mechanism and said end of said first duct, wherein said third bead has a diameter that is less than the diameter of said first bead.

6. The duct joining system of claim 1, wherein one of said first duct and said second duct is a fitting.

7. A duct joining system that simultaneously seals and locks the joint in place consisting of:
a first duct having a female end, said first duct having a first bead on said female end;
a flexible seal and locking mechanism retained within said female end of said first duct between said first bead and an end of said first duct; and
a second duct having a male end having a first cross sectional area and a second bead of a second cross sectional area that is less than said first cross sectional area, said second duct may be joined to the first duct by sliding said female end over said male end, said flexible seal and locking mechanism being compressed by said first cross sectional area, said flexible seal and locking mechanism expanding into said second bead to form both a seal and a mechanical lock that provides resistance to the separation of said first duct and said second duct greater than the resistance to the joining of said first duct and said second duct.

8. The duct joining system of claim 7, wherein said flexible seal and locking mechanism is a flexible gasket held on said female end at an angle relative to normal and away from said end of said first duct.

9. The duct joining system of claim 7, wherein said resistance to the separation of said first duct and said second duct is at least three times greater than said resistance to the joining of said first duct and said second duct.

10. The duct joining system of claim 7, wherein said first bead acts as a stop bead to ensure said second duct is properly positioned with said first duct when said first duct and said second duct are joined.

11. The duct joining system of claim 7, further compromising a third bead on said first duct located between said flexible seal and locking mechanism and said end of said first duct, wherein said third bead has a diameter that is greater than the diameter of said first bead.

12. The duct joining system of claim 7, wherein one of said first duct and said second duct is a fitting.

13. A duct joining system that seals and locks the joint in place consisting of:
a first duct having a male end, said first duct having a first bead on said male end;
a flexible seal and locking mechanism retained on said male end of said first duct between said first bead and an end of said first duct; and
a flexible duct that may be joined to said first duct by sliding said flexible duct over said flexible seal and locking mechanism, said flexible seal and locking mechanism expanding within said flexible duct to form both a seal and a mechanical lock that provides resistance to the separation of said first duct and said flexible duct greater than the resistance to the joining of said first duct and said flexible duct.

14. The duct joining system of claim 13, wherein said flexible seal and locking mechanism is a flexible gasket held on said male end at an angle relative to normal and away from said end of said first duct.

15. The duct joining system of claim 13, wherein said resistance to the separation of said first duct and said second duct is at least three times greater than said resistance to the joining of said first duct and said second duct.

16. The duct joining system of claim 13, further compromising a second bead on said first duct located between said flexible seal and locking mechanism and said end of said first duct, wherein said second bead has a diameter that is less than the diameter of said first bead.

17. The duct joining system of claim 13, wherein said first duct is a fitting.

18. An apparatus comprising:
a first duct;
a second duct, wherein a portion of said first duct is inserted into a portion of said second duct; and
a sealing means for providing a seal and a mechanical connection between said first duct and said second duct when said portion of said first duct is inserted into a portion of said second duct.

19. The apparatus of claim 18, wherein said second duct has a raised bead into which said sealing means is seated to form said seal and said mechanical connection when said portion of said first duct is inserted into said portion of said second duct.

20. The apparatus of claim 18, wherein said first duct has a depressed bead into which said sealing means is seated to form said seal and said mechanical connection when said portion of said first duct is inserted into said portion of said second duct.

21. The apparatus of claim 18, wherein said sealing means is a flexible gasket.

22. The apparatus of claim 21, said first duct having a first bead, said flexible gasket being mounted closer to the front of said first duct than said first bead, said flexible gasket having an angle relative to normal of said first duct.
